(19) United States
(12) Patent Application Publication
(10) Pub. No.: US 2011/0050866 A1
(43) Pub. Date: Mar. 3, 2011

(54) SHUTTER GLASSES FOR DISPLAY APPARATUS AND DRIVING METHOD THEREOF

(75) Inventor: Eun-jong YOO, Yongin-si (KR)

(73) Assignee: SAMSUNG ELECTRONICS CO., LTD., Suwon-si (KR)

(21) Appl. No.: 12/855,746

(22) Filed: Aug. 13, 2010

(30) Foreign Application Priority Data
Aug. 28, 2009 (KR) 10-2009-0080729

(51) Int. Cl. H04N 13/04

(52) U.S. Cl. 348/53; 348/E13.001

(57) ABSTRACT

Shutter-type three-dimensional (3D) glasses used with a display apparatus for displaying a stereoscopic image, and a driving method thereof are provided. The shutter-type 3D glasses include a shutter which includes a left-eye shutter and a right-eye shutter alternately opened and closed in sync with a left-eye image and a right-eye image; a signal receiver which receives a synchronous signal for driving the shutter from the display apparatus; and a shutter driver which determines whether a synchronous signal is normal or abnormal, compensates the synchronous signal if the synchronous signal is abnormal, and supplies the compensated synchronous signal to the shutter.

### CROSS-REFERENCE TO RELATED APPLICATION

This application claims priority from Korean Patent Application No. 10-2009-0080729, filed on Aug. 28, 2009 in the Korean Intellectual Property Office, the disclosure of which is herein incorporated by reference.

### BACKGROUND

1. Field

Apparatuses and methods consistent with exemplary embodiments relate to shutter-type three-dimensional (3D) glasses used with a display apparatus and a driving method thereof, and more particularly, to shutter-type 3D glasses used with a display apparatus and a driving method thereof, which can be minimally affected by noise in 3D image viewing.

2. Description of the Related Art

A 3D image displayed on a display apparatus such as a television (TV) is generally based on binocular parallax that has the largest effect on giving a stereoscopic view at a short distance. Here, the 3D image can be seen through shutter-type 3D glasses, in which the display apparatus quickly displays the left-eye image and the right-eye image alternately, and the shutter-type 3D glasses are opened and closed in sync with the left-eye image and the right-eye image to thereby achieve viewing of the 3D image. Specifically, the 3D glasses have an opened left-shutter and a closed right-shutter while the display apparatus displays the left-eye image, and have a left-shutter and an opened right-shutter while the display apparatus displays the right-eye image.

Such shutter-type 3D glasses receive a synchronous signal in the form of an infrared (IR) signal from the display apparatus and convert the received IR signal into a signal to be applied to operate the shutter-type 3D glasses. However, noise may be generated when the shutter-type 3D glasses receive the synchronous signal. Accordingly, an error pulse may be added to the synchronous signal, or a part of the synchronous signal may be omitted. In result, noise may cause incorrect synchronization between the display apparatus and the shutter-type 3D glasses. That is, the left-eye shutter and the right-eye shutter of the shutter-type 3D glasses have to be opened and closed in sync with the alternation between the left-eye image and the right-eye image of the display apparatus. However, the noise may cause the shutter-type 3D glasses to be out of synchronization with the display apparatus, thereby showing an unstable screen.

### SUMMARY

One or more exemplary embodiments provide shutter-type 3D glasses and a driving method thereof, which can synchronize with 3D images of a display apparatus by minimizing an effect of noise even though a synchronous signal with noise is received from the display apparatus.

According to an aspect of an exemplary embodiment, there is provided shutter-type 3D glasses for showing a left-eye image and a right-eye image alternately displayed on a display apparatus, the shutter-type 3D glasses including a shutter which includes a left-eye shutter and a right-eye shutter alternately opened and closed in sync with the left-eye image and the right-eye image; a signal receiver which receives a synchronous signal for driving the shutter from the display apparatus; and a shutter driver which supplies the synchronous signal to the shutter if the synchronous signal corresponds to a previously received signal, and compensates and supplies the synchronous signal to the shutter if the synchronous signal does not correspond to a previously received signal.

If one or more pulses are added to the synchronous signal, the shutter driver may compensate the synchronous signal by excluding the added pulses.

If one or more pulses are omitted from the synchronous signal, the shutter driver may compensate the synchronous signal by generating a signal having a certain period.

The shutter driver may generate and supply the signal having the certain period to the shutter, and interrupt the generation of the signal having the certain period if the synchronous signal received from the display apparatus within a certain time is determined as the signal having the certain period.

The signal receiver may receive an infrared signal from the display apparatus.

According to another illustrative aspect of the present invention, there is provided a method of driving shutter-type 3D glasses, the method including receiving a synchronous signal for driving a left-eye shutter and a right-eye shutter alternately opened and closed in sync with a left-eye image and a right-eye image alternately displayed on a display apparatus; determining whether the synchronous signal corresponds to a previously received signal; and compensating the synchronous signal if the synchronous signal does not correspond to the previously received signal.

If one or more pulses are added to the synchronous signal, the synchronous signal may be compensated by excluding the added pulses.

If one or more pulses are omitted from the synchronous signal, the synchronous signal may be compensated by generating a signal having a certain period.

If the synchronous signal received from the display apparatus within a certain time is determined as the signal having the preset period after the signal having the preset period is generated, the generation of the signal having the preset period may be interrupted.

The receiving the synchronous signal for driving the left-eye shutter and the right-eye shutter may include receiving an infrared signal from the display apparatus.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of shutter-type 3D glasses according to an exemplary embodiment;

FIG. 2 is a view for explaining noise to be compensated for in the shutter-type 3D glasses according to an exemplary embodiment;

FIG. 3 is a view for explaining how the shutter-type 3D glasses according to an exemplary embodiment are driven in the case that a pulse due to noise is added to an IR signal;

FIG. 4 is a view for explaining how the shutter-type 3D glasses according to an exemplary embodiment are driven in the case that a pulse is omitted from the IR signal due to noise;

FIG. 5 is a flowchart showing operations of the shutter-type 3D glasses according to an exemplary embodiment;

FIG. 6 is a flowchart showing operations for compensating the synchronous signal in the shutter-type 3D glasses according to an exemplary embodiment; and

FIG. 7 is a flowchart showing operations for compensation in the case that a pulse constituting the synchronous signal for the shutter-type 3D glasses is omitted.

### DETAILED DESCRIPTION

Below, exemplary embodiments will be described in detail with reference to accompanying drawings so as to be easily realized by a person having ordinary knowledge in the art. The present invention may be embodied in various forms without being limited to the exemplary embodiments set forth herein. Descriptions of well-known parts are omitted for clarity, and like reference numerals refer to like elements throughout.

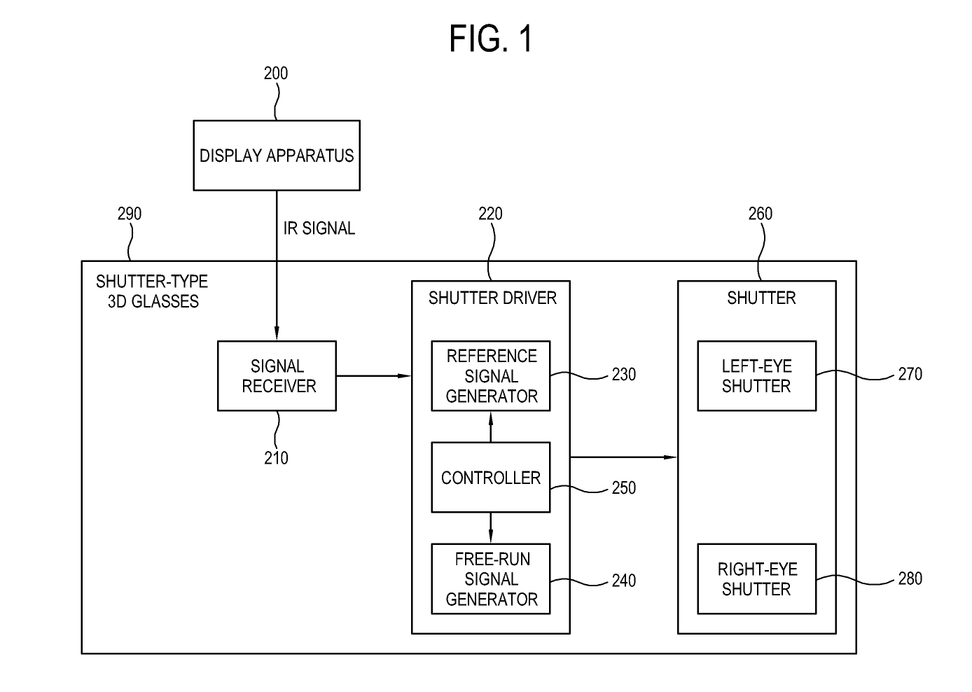

FIG. 1 is a block diagram of shutter-type 3D glasses according to an exemplary embodiment. As shown in FIG. 1, shutter-type 3D glasses 290 in this exemplary embodiment include a signal receiver 210, a shutter driver 220, and a shutter 260. The shutter driver 220 includes a reference signal generator 230, a free-run signal generator 240, and a controller 250. The shutter 260 includes a left-eye shutter 270 and a right-eye shutter 280. The signal receiver 210 receives a synchronous signal from the display apparatus 200, and the shutter driver 220 drives the shutter 260 on the basis of the synchronous signal received in the signal receiver 210. The controller 250 of the shutter driver 220 determines whether the synchronous signal is normal, and controls operations of the reference signal generator 230 and the free-run signal generator 240. The reference signal generator 230 generates a reference signal to compensate the synchronous signal if a pulse is added to the synchronous signal, and the free-run signal generator 240 generates a free-run signal to compensate the synchronous signal if a pulse is omitted from the synchronous signal.

A display apparatus 200 transmits the synchronous signal in the form of an infrared (IR) signal to the shutter-type 3D glasses 290. Here, the IR signal may have a wavelength of about 8300 Å. The infrared travels more straight and has higher reflectivity than a wave having a lower frequency. The signal receiver 210 receives the synchronous signal in the form of the IR signal from the display apparatus 200, and converts the IR signal in order to apply the signal to the shutter-type 3D glasses 290, thereby supplying the signal to the shutter driver 220. The shutter driver 220 drives the left-eye shutter 270 and the right-eye shutter 280 of the shutter 260 to be alternately opened and closed on the basis of the synchronous signal supplied from the signal receiver 210. Meanwhile, the IR signal received from the display apparatus 200 may contain noise. The noise may cause an error pulse to be added to the IR signal, or the IR signal's own pulse to be omitted. As a result, the synchronous signal obtained by converting the IR signal to apply the signal to the shutter-type 3D glasses 290 may have noise.

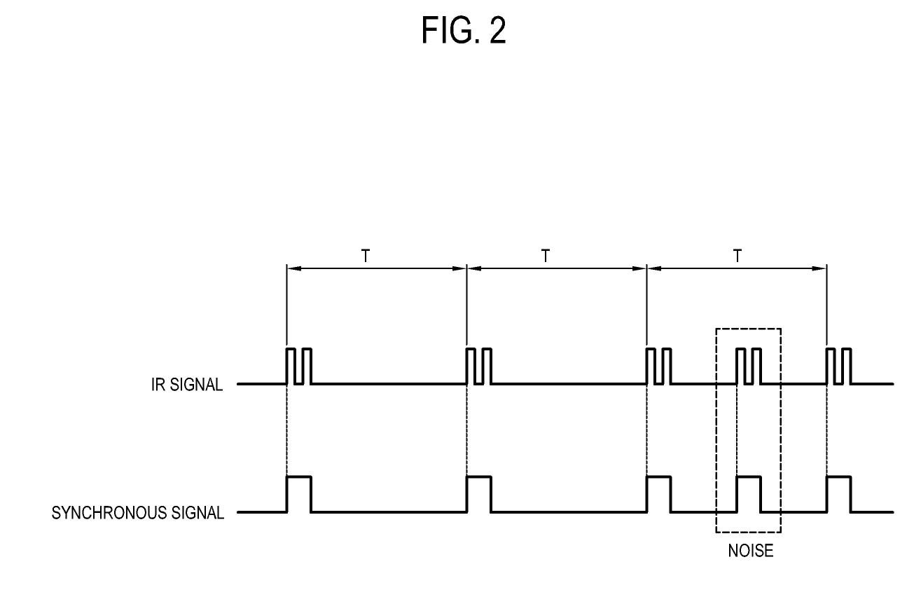

FIG. 2 is a view for explaining noise to be compensated for in the shutter-type 3D glasses according to an exemplary embodiment. As shown in FIG. 2, if the error pulse is added to the IR signal, the added pulse is also converted into the synchronous signal. Due to the noise, the left-eye shutter 270 and the right-eye shutter 280 of the shutter-type 3D glasses 290 may not be coincidentally opened and closed in sync with the change in the left-eye image and the right-eye image alternately displayed on the display apparatus 200. Thus, when receiving the synchronous signal from the signal receiver 210, the shutter driver 220 in this exemplary embodiment drives the shutter 260 on the basis of the synchronous signal if the synchronous signal has no noise, or compensates the synchronous signal and supplies the compensated signal to the shutter 260 if the synchronous signal has noise. Accordingly, even though the synchronous signal has noise, the shutter-type 3D glasses 290 can be accurately synchronized with the display apparatus 200, so that a user can be provided with a stable screen.

Next, a method of compensating the noise of the synchronous signal of the shutter driver 220 according to an exemplary embodiment will be described.

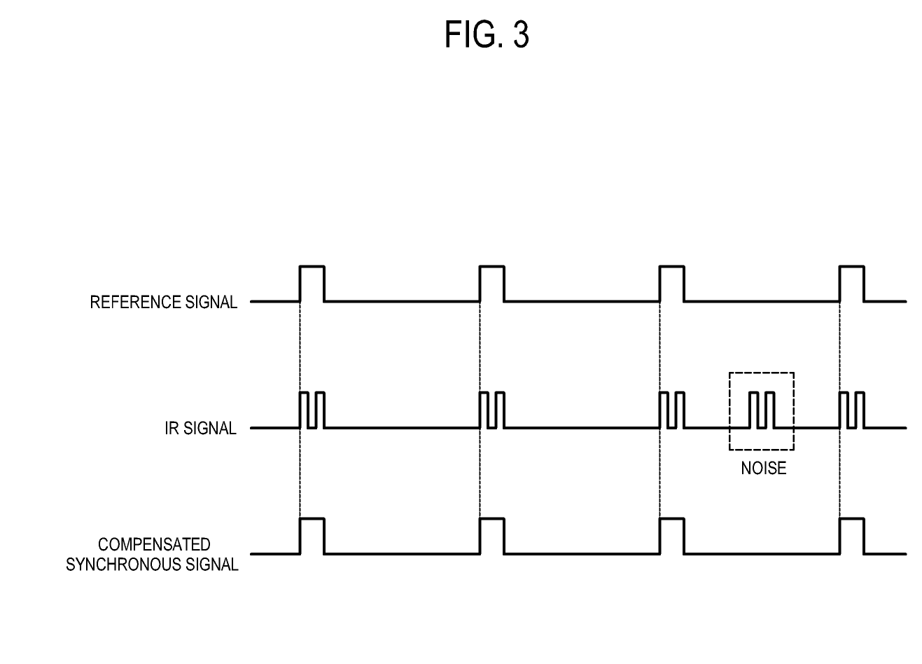

FIG. 3 is a view for explaining how the shutter-type 3D glasses according to an exemplary embodiment are driven in the case that a pulse due to noise is added to an IR signal. As illustrated in FIG. 3, if the error pulse due to the noise is added to the IR signal, the shutter-type 3D glasses 290 according to an exemplary embodiment may use a reference signal to exclude the noise. In this exemplary embodiment, the reference signal is a signal based on a previously received synchronous signal, which includes a signal that has no noise. The controller 250 controls the reference signal generator 230 to generate the reference signal on the basis of a corresponding synchronous signal if a currently received synchronous signal is a signal in which pulses are regularly generated per preset period. In other words, the controller 250 controls the reference signal generator 230 to generate a reference signal that has a period that is equal to the period of the synchronous signal being received from the display apparatus. The reference signal is then compared to the currently received synchronous signal. Because the reference signal has no noise, it is possible to determine the state of the currently received synchronous signal by comparing the reference signal with the currently received synchronous signal. That is, if the reference signal corresponds to the currently received synchronous signal, it is determined that the currently received synchronous signal also has no noise. On the other hand, if the reference signal does not correspond to the currently received synchronous signal, it is determined that the currently received synchronous signal has noise. As an example of a method for determining whether the reference signal corresponds to the currently received synchronous signal, it is determined that the currently received synchronous signal has no noise if the pulse of the reference signal is matched with the pulse of the currently received synchronous signal. Otherwise, it is determined that the currently received synchronous signal has noise. When it is determined that the currently received synchronous signal includes additional pulses due to noise, the controller 250 excludes the pulses regarded as the noise and supplies the synchronous signal to the shutter 260. If the shutter-type 3D glasses 290 are driven in such a manner, it is possible to exclude an effect of noise while driving the shutter 260 even though the IR signal has noise.

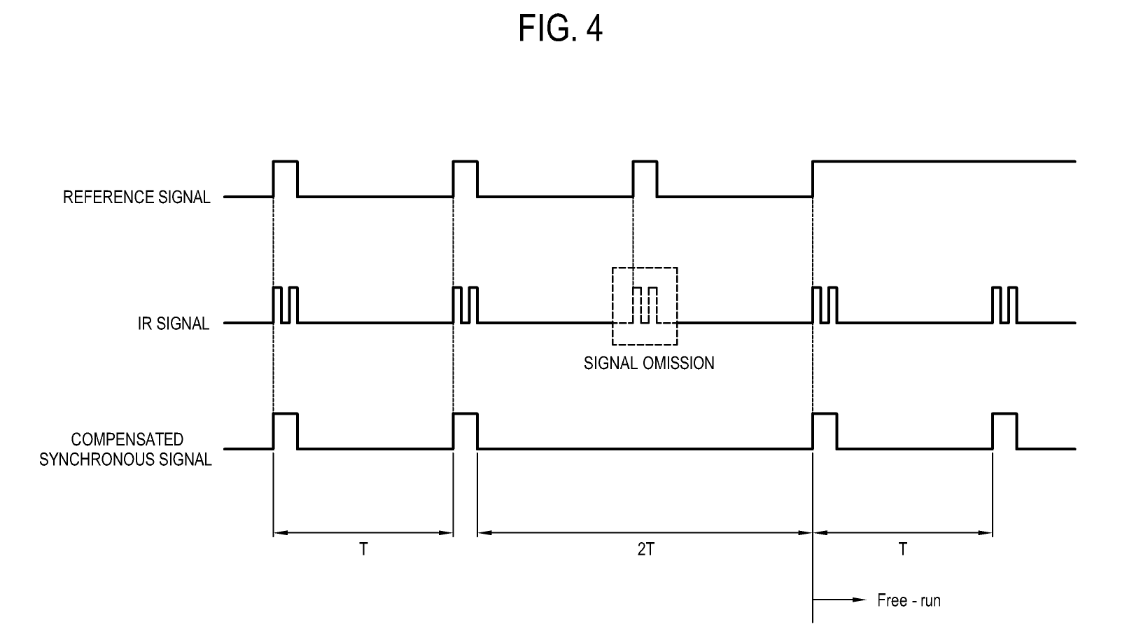

FIG. 4 is a view for explaining how the shutter-type 3D glasses 290 according to an exemplary embodiment are driven in the case that a pulse is omitted from the IR signal due to noise. As shown in FIG. 4, if some pulses are omitted from the IR signal, the synchronous signal converted therefrom also has omitted pulses. At this time, the shutter-type 3D glasses 290 in this exemplary embodiment determine whether the reference signal corresponds to the currently received synchronous signal, and ascertain that the currently received synchronous signal has no pulse at a point in time when the reference signal has a pulse. In this case, the controller 250 determines that the currently received synchronous signal contains noise, and compensates the corresponding synchronous signal, thereby supplying the compensated synchronous signal to the shutter 260. As a method of compensating the synchronous signal, the controller 250 adds the omitted signal and supplies the compensated signal to the shutter 260. As an alternative method for compensating the synchronous signal, the controller 250 may employ a “free-run signal.” That is, if some pulses are omitted from the currently received synchronous signal, the controller 250 controls the free-run signal generator 240 to generate a free-run signal, and supplies the generated free-run signal to the shutter 260.

In this exemplary embodiment, the free-run signal is a signal generated per period T. The period T may be preset. For example, the free-run signal may have the same period as the synchronous signal received from the display apparatus 200. The generation of the free-run signal may begin at a point in time when it is finally determined that the currently received signal has normal pulses before some pulses are omitted therefrom. In the case of FIG. 4, a point in time when the pulses are omitted elapses by one period T from a time when it is finally determined that the currently received signal has the normal pulses, so that the point in time when the free-run signal is generated with pulses elapses by two periods 2T from the point in time when it is finally determined that the currently received signal has normal pulses. Then, the pulses are periodically generated by a certain period T.

Meanwhile, the controller 250 controls the reference signal to be maintained in a certain state while the free-run signal is used for driving the shutter 260, because the reference signal is based on the previously received synchronous signal and it is thus difficult to guarantee reliability of a reference signal if some pulses are omitted from the previously received synchronous signal. Accordingly, the controller 250 generates the reference signal again and determines whether the synchronous signal currently received without the reference signal is configured by a certain period until the reference signal is generated again. The certain period may be reset. If it is determined that the currently received synchronous signal is configured by the certain period, the controller 250 controls the free-run signal generator 240 and interrupts the generation of the free-run signal, thereby supplying the currently received synchronous signal to the shutter 260. Also, the controller 250 controls the reference signal generator 230 to generate the reference signal again on the basis of the corresponding synchronous signal.

Next, operations of the shutter-type 3D glasses according to an exemplary embodiment will be described.

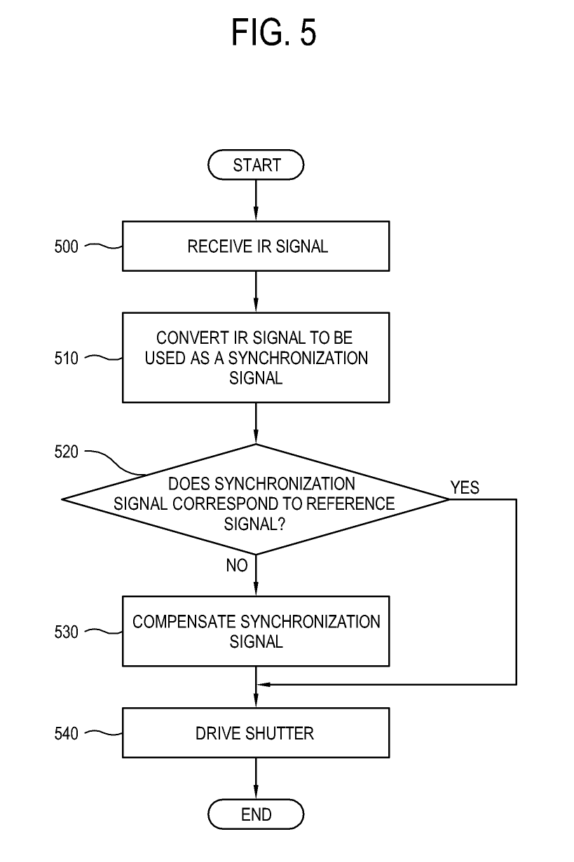

FIG. 5 is a flowchart showing operations of the shutter-type 3D glasses 290 according to an exemplary embodiment. As shown in FIG. 5, the signal receiver 210 of the shutter-type 3D glasses 290 receives the IR signal from the display apparatus 200 at operation 500, and converts the IR signal to be used as the synchronous signal for the shutter-type 3D glasses 290 at operation 510, thereby supplying the converted signal to the shutter driver 220. The shutter driver 220 determines whether the synchronous signal corresponds to the reference signal generated on the basis of the previously received signal at operation 520, and supplies the synchronous signal to the shutter 260 directly to drive the left-eye shutter 270 and the right-eye shutter 280 at operation 540 if it is determined that the signals correspond to each other. On the other hand, if it is determined that the signals do not correspond to each other, the synchronous signal is compensated at operation 530 and then supplied to the shutter 260.

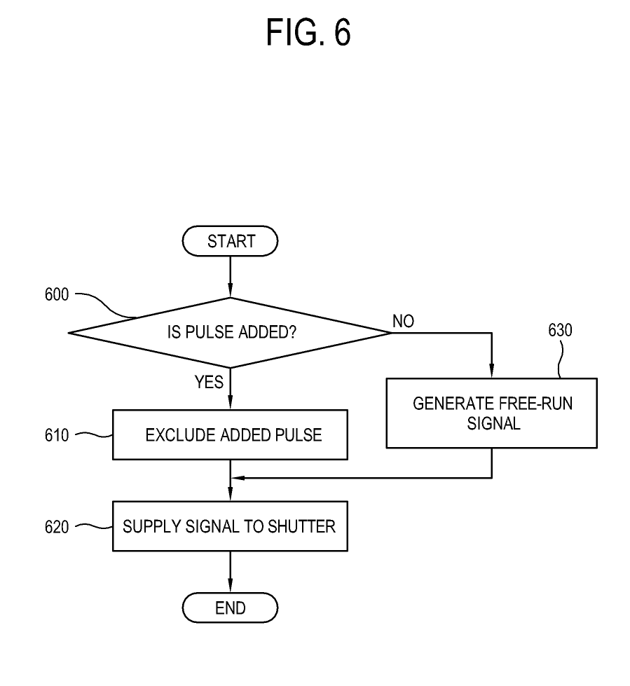

FIG. 6 is a flowchart showing operations for compensating the synchronous signal in the shutter-type 3D glasses 290 according to an exemplary embodiment. These operations are performed at operation 530 in FIG. 5. As shown in FIG. 6, if it is determined at operation 600 that the synchronous signal does not correspond to the reference signal, and particularly, if an error pulse is added to the synchronous signal, the additional pulses are excluded at operation 610, so that the synchronous signal can be supplied to the shutter 260. On the other hand, if no pulses are added (NO in operation 600), then some pulses must be omitted, and accordingly, the free-run signal is generated at operation 630 and supplied to the shutter 260.

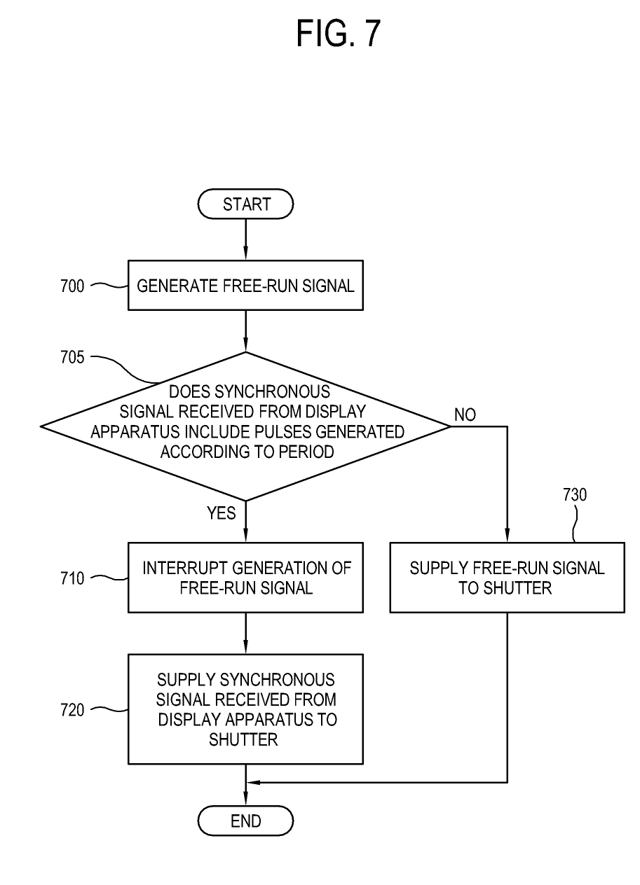

FIG. 7 is a flowchart showing operations for compensation in the case that a pulse constituting the synchronous signal for the shutter-type 3D glasses 290 is omitted. These operations are performed at operation 630 in FIG. 6. As shown in FIG. 7, if the free-run signal is employed for driving the shutter 260 at operation 700, the controller 250 determines whether the synchronous signal received from the display apparatus 200 within a certain time includes pulses generated per certain period at operation 705. The certain time may be a threshold time and may be predetermined, and the certain period may be preset. If the synchronous signal includes the pulses generated at the certain period, the controller 250 controls the free-run signal 240 to interrupt the generation of the free-run signal at operation 710, and supplies the synchronous signal from the display apparatus 200 to the shutter 260 at operation 720. On the other hand, if it seems that the synchronous signal is not configured with the pulses generated at the certain period, the shutter 260 is driven by the free-run signal at operation 730.

As described above, according to exemplary embodiments, noise is removed or an effect of noise is minimized even though noise is generated when a synchronous signal is received from a display apparatus. Further, the synchronous signal received from the display apparatus is compensated regardless of a position of the shutter-type 3D glasses or the position of a user, so that the shutter-type 3D glasses can be more accurately synchronized with the display apparatus.

Although a few exemplary embodiments have been shown and described, it will be appreciated by those skilled in the art that changes may be made in these embodiments without departing from the principles and spirit of the invention, the scope of which is defined in the appended claims and their equivalents.

What is claimed is:

1. Shutter-type three-dimensional (3D) glasses for showing a left-eye image and a right-eye image alternately displayed on a display apparatus, the shutter-type 3D glasses comprising:
a shutter which comprises a left-eye shutter and a right-eye shutter alternately opened and closed in sync with the left-eye image and the right-eye image;
a signal receiver which receives a synchronous signal for driving the shutter from the display apparatus; and
a shutter driver which supplies the synchronous signal to the shutter if the synchronous signal corresponds to a previously received signal, and compensates the synchronous signal and supplies the compensated signal to the shutter if the synchronous signal does not correspond to a previously received signal.

2. The shutter-type 3D glasses according to claim 1, wherein, if at least one pulse is added to the synchronous signal, the shutter driver compensates the synchronous signal by excluding the at least one pulse.

3. The shutter-type 3D glasses according to claim 1, wherein, if at least one pulse is omitted from the synchronous signal, the shutter driver compensates the synchronous signal by generating a signal having a certain period.

4. The shutter-type 3D glasses according to claim 3, wherein the shutter driver generates and supplies the signal having the certain period to the shutter, and interrupts the generation of the signal having the certain period if the synchronous signal received from the display apparatus within a certain time is determined as the signal having the certain period.

5. The shutter-type 3D glasses according to claim 1, wherein the signal receiver receives an infrared signal from the display apparatus.

6. The shutter-type 3D glasses according to claim 1, wherein the synchronous signal is an infrared signal.

7. A method of driving shutter-type three-dimensional (3D) glasses, the method comprising:
receiving a synchronous signal for driving a left-eye shutter and a right-eye shutter alternately opened and closed in sync with a left-eye image and a right-eye image alternately displayed on a display apparatus;
determining whether the synchronous signal corresponds to a previously received signal; and
compensating the synchronous signal if the synchronous signal does not correspond to the previously received signal.

8. The method according to claim 7, wherein, if at least one pulse is added to the synchronous signal, the synchronous signal is compensated by excluding the at least one pulse.

9. The method according to claim 7, wherein, if at least one pulse is omitted from the synchronous signal, the synchronous signal is compensated by generating a signal having a certain period.

10. The method according to claim 9, wherein, if the synchronous signal received from the display apparatus is determined within a certain time as the signal having the certain period after the signal having the certain period is generated, the generation of the signal having the certain period is interrupted.

11. The method according to claim 7, wherein the receiving the synchronous signal comprises receiving an infrared signal from the display apparatus.
